(19) United States
(12) Patent Application Publication
(10) Pub. No.: US 2006/0031864 A1
(43) Pub. Date: Feb. 9, 2006

(54) Spindle motor, disc driving apparatus having the same, and production method thereof

(76) Inventors: Hiroyuki Kiriyama, Ozu-shi (JP); Toshiyuki Iwahori, Mishima-gun (JP); Hitoshi Fujino, Ozu-shi (JP); Yoichi Oki, Ozu-shi (JP)

Correspondence Address: WENDEROTH, LIND & PONACK L.L.P., 2033 K. STREET, NW, SUITE 800, WASHINGTON, DC, 20006, US

(21) Appl. No.: 11/196,734

(22) Filed: Aug. 4, 2005

(30) Foreign Application Priority Data
Aug. 9, 2004 (JP) 2004-232756

(51) Int. Cl. G11B 7/08

(52) U.S. Cl. 720/658

(57) ABSTRACT

The present invention provides a small and thin spindle motor in which no uneven pressure is applied to a recording medium when the recording medium is fixed to a hub, a disc driving apparatus having the spindle motor, and a production method thereof. The spindle motor comprises: a sleeve which is supported by a fixed shaft and rotates around a predetermined axis; and a hub provided on an outer peripheral portion of the sleeve, which includes: a tubular portion to be inserted into a central hole of a recording medium having a disc shape, which is coaxial with the sleeve and has a male thread formed on an outer peripheral surface; and a first receiving surface which is connected to the tubular portion and which holds the recording medium to the axis.

### BACKGROUND OF THE INVENTION

1. Field of the Invention

The present invention relates to a spindle motor, a disc driving apparatus having the same, and a production method thereof.

2. Description of the Related Art

In recent years, there is a demand for smaller and thinner disc driving apparatuses for incorporating them into microminiature portable terminals such as portable music players, digital video cameras and the like. For example, there is a demand for disc driving apparatuses using discs having a diameter of 1 inch or smaller. Disc driving apparatuses use spindle motors for rotationally driving recording media such as magnetic discs, optical discs and the like. As the disc driving apparatuses become smaller and thinner, there is a growing demand for smaller and thinner spindle motors.

Japanese Laid-Open Publication No. 2000-32725 discloses an example of a conventional disc driving apparatus.

A conventional disc driving apparatus with a recording medium attached to a spindle motor will be described with reference to FIGS. 7 and 8. FIG. 7 is a cross-sectional view showing a right half of a disc driving apparatus having a typical conventional spindle motor. Since the other half on the left-hand side with respect to a central axis (axis 41a) has the same structure as the right half, it is not shown in the figure. FIG. 8 is a plan view of a top end portion of a hub in the disc driving apparatus.

As shown in FIG. 7, a lower end portion of a shaft 41 is fixed to a base 43. A thrust flange 49 having a disc shape is fixed to an outer peripheral surface of the shaft 41 or the thrust flange 49 is integrally formed with the shaft 41. A sleeve 42 has a cylindrical portion 42a, and a thrust plate 52 having a ring shape is press-fitted or adhered to an inner peripheral surface of the cylindrical portion 42a. The thrust flange 49 is positioned in a space defined by the sleeve 42, the cylindrical portion 42a, and the thrust plate 52. The sleeve 42 and the thrust plate 52 are rotatably supported by the shaft 41. On one of a lower surface of the thrust plate 52 and an upper surface of the thrust flange 49, one of a lower surface of the thrust flange 49 and an upper surface of the sleeve 42, and one of the outer peripheral surface of the shaft 41 and an inner peripheral surface of the sleeve 42, a dynamic pressure generating groove (not shown) having a herringbone shape or the like which is well-known in the art is respectively provided. In gaps between the shaft 41 and the thrust plate 52, the thrust flange 49 and the thrust plate 52, the thrust flange 49 and the cylindrical portion 42a, the thrust flange 49 and the sleeve 42, and the shaft 41 and the sleeve 42, oil for lubrication is filled to form a hydrodynamic bearing.

On an outer peripheral surface of the sleeve 42, a hub 44 holding a rotor magnet 45 is attached. A motor stator 46 is attached to a base 43 on a surface which opposes the rotor magnet 45. The hub 44 includes a tubular portion 44a to be inserted into a central hole 48a of a disc 48. The hub 44 also includes a first receiving surface 44b which is connected to the tubular portion 44a and elongated perpendicular to the axis 41a for holding the disc 48. The disc 48 is a medium used for recording and/or reproduction. As will be described in detail below, the disc 48 is interposed and fixed between the first receiving surface 44b and a damper 47 of a ring shape.

With reference to FIG. 8, an upper end portion 44e of the hub 44 will be described. As shown in FIG. 8, female threads 44c and positioning holes 44f are provided on the upper end portion 44e of the hub 44 in a concentric pattern having the axis 41a as a central axis. Three female threads 44c are provided with central angles of 120° with respect to the axis 41a. Two positioning holes 44f are provided in a point symmetric with respect to the axis 41a at positions such that they do not overlap the female threads 44c.

A production process for a disc driving apparatus having such a conventional spindle motor will be described. The tubular portion 44a of the hub 44 is inserted to the central hole 48a of the disc 48. The disc 48 is placed on the first receiving surface 44b. Next, the damper 47 having a ring shape is placed on the upper end portion 44e of the hub 44. A male screw 44d is screwed into each of the three female threads 44c through a hole 47a of the damper 47. Thus, the damper 47 is fixed to the hub 44. In such a state, a bent portion 47b of the damper 47 applies a pressure on an upper surface of the disc 48 and presses the disc 48 against the receiving surface 44b to fix the disc 48.

In general, in order to miniaturize and reduce a thickness of a spindle motor, each of the parts forming the spindle motor has to be miniaturized and have a reduced thickness. As a result, strengths of the parts are relatively deteriorated. Thus, as the spindle motor becomes smaller and thinner, problems such that the hub is deformed due to a clinching force of the male screws when a recording medium such as the disc 48 is fixed tend to occur.

Further, in the conventional spindle motor, for fixing the disc 48, the male screws 44d are screwed into female threads 44c provided on the top end portion 44e of the hub 44 to deform the damper 47 and a pressure generated by such deformation fixes the disc 48. In such a structure, a pressure applied to the disc 48 by deformation of the damper 47 near the female threads 44c into which the male screws 44d are screwed is larger than the pressure applied to the rest of the disc. Specifically, since the damper 47 of a ring shape is fixed with three male screws 44d, the damper 47 is distorted. Thus, the pressure applied by the bent portion 47b of the damper 47 to the disc 48 is large near the female threads 44c and is small in portions between the female threads 44c adjacent to each other. This causes an uneven pressure to be applied to the disc 48. In general, the thickness of the recording medium is as thin as about 0.5 mm. Thus, such an uneven pressure may cause a strain or deflection in the recording medium. In order to suppress occurrence of such a strain and deflection, a method of increasing the number of the points to be screwed (for example, to six or more) has been proposed. However, such a method suffers from a problem of an increase in the production cost due to an increase in the number of the parts.

The object of the present invention to provide a small and thin spindle motor in which no uneven pressure is applied to a recording medium when the recording medium is fixed to a hub, a disc driving apparatus having the same, and a production method thereof.

### SUMMARY OF THE INVENTION

A spindle motor according to claim 1 comprises: a sleeve which is supported by a fixed shaft and rotates around a predetermined axis; and a hub provided on an outer peripheral portion of the sleeve, which includes: a tubular portion to be inserted into a central hole of a recording medium having a disc shape, which is coaxial with the sleeve and has a male thread formed on an external surface; and a first receiving surface which is connected to the tubular portion and which holds the recording medium to the axis.

According to the present invention, a fixing member having a female thread which will be described below is screwed into the male thread provided on the outer peripheral surface of the hub when the recording medium is fixed to the hub. In this way, a uniform pressure is applied to the entire circumference of the recording medium. Thus, a spindle motor which does not generate a strain or deflection can be provided.

In a spindle motor according to claim 2, the hub includes at least two positioning holes formed on a surface opposing the first receiving surface in an axial direction.

According to the present invention, a fixing member having a female thread which will be described below is screwed into the male thread provided on the outer peripheral surface of the hub when the recording medium is fixed to the hub. In this way, a uniform pressure is applied to the entire circumference of the recording medium. Thus, no strain or deflection is generated. Further, since the positioning holes are formed on a surface opposing the first receiving surface in an axial direction, the female thread 44c and the positioning holes 44f provided in the conventional example are no longer necessary. Thickness of the tubular portion in the radial direction may be any value as long as it gives a sufficient strength for the male thread to hold the fixing member. Unnecessarily large thickness is not required. Thus, the thickness of the tubular portion in the radial direction can be minimized. Further, since the positioning jig is inserted into the positioning holes when the fixing member is screwed into the male thread of the tubular portion of the hub, deformation and the like of the hub can be reduced. In this way, it is possible to provide a spindle motor which is miniaturized and have a reduced thickness while a strain or deflection of the recording medium generated due to the uneven pressure applied when the recording medium is fixed to the hub being eliminated and deformation of the hub due to deterioration of the relative strengths of the parts being suppressed.

A spindle motor according to claim 3 comprises a base which is fixed to the shaft and includes at least two openings which oppose the positioning holes and are larger than the positioning holes.

According to the present invention, the positioning jig can be inserted into the positioning holes through the openings even after the base is attached. Thus, it is possible to provide a spindle motor with the recording medium fixed to the hub while the deformation of the hub having the relatively deteriorated strength due to miniaturization being prevented.

A spindle motor according to claim 4 comprises a hydrodynamic bearing having a lubricant formed between the shaft and the sleeve.

According to the present invention, a hydrodynamic bearing having a low noise and a high rotation precision is used. In this way, it is possible to provide a spindle motor which is miniaturized and have a reduced thickness while a strain or deflection of the recording medium generated due to the uneven pressure applied when the recording medium is fixed to the hub being eliminated and deformation of the hub due to deterioration of the relative strengths of the parts being suppressed.

A disc driving apparatus according to claim 5 comprises: a sleeve which is supported by a fixed shaft and rotates around a predetermined axis; a hub which is provided on an outer peripheral portion of the sleeve, including a tubular portion to be inserted into a central hole of a recording medium having a disc shape, which is coaxial with the sleeve, and a first receiving surface which is connected to the tubular portion and holds the recording medium to the axis; and a fixing member which is attached to an outer peripheral surface of the tubular portion of the hub and fixes a recording medium placed on the first receiving surface, wherein the fixing member is a member having a ring shape fixed to the tubular portion by a shrinkage fit.

According to the present invention, a fixing member which has a ring shape and fixes the recording medium is shrinkage-fitted to the outer peripheral surface of the tubular portion of the hub. In this way, a uniform pressure is applied to entire circumference of the recording medium. Thus, no strain or deflection is generated. Further, no pressure which may generate deformation and the like of the hub is generated. Since the fixing member is provided on an outer peripheral surface of the tubular portion of the hub, the thickness of the disc driving apparatus in the axial direction can be reduced by a thickness of the head of the male thread 44d and the upper surface of the damper 7 which are located above the upper end portion 44e in the conventional example. In this way, it is possible to provide a disc driving apparatus which is miniaturized and have a reduced thickness while a strain or deflection of the recording medium generated due to the uneven pressure applied when the recording medium is fixed to the hub being eliminated and deformation of the hub due to deterioration of the relative strengths of the parts being suppressed.

In a disc driving apparatus according to claim 6 comprises: a sleeve which is supported by a fixed shaft and rotates around a predetermined axis; a hub which is provided on an outer peripheral portion of the sleeve, including a tubular portion to be inserted into a central hole of a recording medium having a disc shape, which is coaxial with the sleeve and has a male thread formed on an outer peripheral surface, and a first receiving surface which is connected to the tubular portion and holds the recording medium to the axis; and a fixing member which is attached to an outer peripheral surface of the tubular portion of the hub and fixes a recording medium placed on the first receiving surface, wherein the fixing member has a female thread to be attached to the male thread on an inner peripheral surface thereof.

According to the present invention, a fixing member is screwed into the male thread provided on the outer peripheral surface of the hub when the recording medium is fixed to the hub. In this way, a uniform pressure is applied to entire circumference of the recording medium. Thus, no strain or deflection is generated. In this way, it is possible to provide a disc driving apparatus with a strain or deflection of the recording medium generated due to the uneven pressure applied when the recording medium is fixed to the hub being eliminated.

In a disc driving apparatus according to claim 7, the hub further includes at least two positioning holes formed on a surface opposing the first receiving surface in an axial direction.

According to the present invention, a fixing member is fixed or shrinkage-fitted to the outer peripheral surface of the tubular portion of the hub when the recording medium is fixed to the hub, and further, positioning holes are formed on a surface opposing the first receiving surface in the axial direction. In this way, the female thread 44c and the positioning holes 44f provided in the conventional example are no longer necessary. Thickness of the tubular portion in the radial direction may be any value as long as it gives a sufficient strength for the male thread to hold the fixing member. Unnecessarily large thickness is not required. Thus, the thickness of the tubular portion in the radial direction can be minimized. Further, since the positioning jig is inserted into the positioning holes when the fixing member is attached to the outer peripheral surface of the tubular portion of the hub, deformation and the like of the hub can be reduced. In this way, it is possible to provide a disc driving apparatus which is miniaturized and have a reduced thickness while a strain or deflection of the recording medium generated due to the uneven pressure applied when the recording medium is fixed to the hub being eliminated and deformation of the hub due to deterioration of the relative strengths of the parts being suppressed.

A disc driving apparatus according to claim 8 further comprises a base which is fixed to the shaft and includes at least two openings which oppose the positioning holes and are larger than the positioning holes.

According to the present invention, the positioning jig can be inserted into the positioning holes through the openings even after the base is attached. Thus, it is possible to provide a disc driving apparatus with the recording medium fixed to the hub while the deformation of the hub having the relatively deteriorated strength due to miniaturization being prevented.

A disc driving apparatus according to claim 9 comprises a hydrodynamic bearing having a lubricant which is formed between the shaft and the sleeve.

According to the present invention, a hydrodynamic bearing having a low noise and a high rotation precision is used. In this way, it is possible to provide a disc driving apparatus which is miniaturized and have a reduced thickness while a strain or deflection of the recording medium generated due to the uneven pressure applied when the recording medium is fixed to the hub being eliminated and deformation of the hub due to deterioration of the relative strengths of the parts being suppressed.

A method for producing a spindle motor according to claim 10 is a method for producing a spindle motor including a hub unit and a base unit. The hub unit includes a bearing unit including a shaft and a sleeve which is relatively rotatable with respect to the shaft, a hub unit including a hub which is fixed one of the shaft or the sleeve and on which a recording medium can be placed and a rotor magnet to be fixed to the hub. The base unit includes a base fixed to the other of the shaft and the sleeve and a stator fixed in the base opposing the rotor magnet in a radial direction. The method for producing a spindle motor of the present invention comprises: inserting a positioning restriction section for restricting an axial direction position of the hub unit relatively into an opening provided in the base from the side of base unit with the hub unit and the base unit being spaced apart from each other in an axial direction to abut the hub unit against the hub; and moving the base unit and the hub unit relatively along the positioning restriction section to positioning and fix the base unit to the hub unit.

According to the present invention, the base unit and the hub unit are positioned and fixed with the position of the hub unit being restricted by the position restriction section. Thus, it is possible to prevent the hub unit from adsorbing to the base unit with a shock by adsorption force of the rotor magnet while being positioned and fixed. In this way, it becomes possible to simplify the structure of the positioning and fixing apparatus for positioning and fixing, which may result in reducing the cost for equipment.

A method for producing a disc driving apparatus according to claim 11 comprises a spindle motor which includes: a sleeve which is supported by a fixed shaft and rotates around a predetermined axis; and a hub which is provided on an outer peripheral portion of the sleeve, including a tubular portion to be inserted into a central hole of a recording medium having a disc shape, which is coaxial with the sleeve, and a first receiving surface which is connected to the tubular portion and holds the recording medium to the axis, the method comprising: inserting the tubular portion of the hub into a central hole of the recording medium to attach the recording medium to the first receiving surface; and inserting the fixing member with a shrinkage fit to an outer peripheral surface of the tubular potion of the hub to fix the recording medium.

According to the present invention, the fixing member which has a ring shape and fixes the recording medium is shrinkage-fitted to the tubular portion of the hub. In this way, it is possible to provide a method for producing a disc driving apparatus which is miniaturized and have a reduced thickness while a strain or deflection of the recording medium generated due to the uneven pressure applied when the recording medium is fixed to the hub being eliminated and deformation of the hub due to deterioration of the relative strengths of the parts being suppressed.

A method for producing a disc driving apparatus according to claim 12 comprises a spindle motor which includes: a sleeve which is supported by a fixed shaft and rotates around a predetermined axis; and a hub which is provided on an outer peripheral portion of the sleeve, including a tubular portion to be inserted into a central hole of a recording medium having a disc shape, which is coaxial with the sleeve and has a male thread formed on an outer peripheral surface, a first receiving surface which is connected to the tubular portion and holds the recording medium to the axis, and at least two positioning holes formed on a surface opposing the first receiving surface in an axial direction, the method comprising: inserting the tubular portion of the hub into a central hole of the recording medium to attach the recording medium to the first receiving surface; inserting a positioning jig into the positioning holes to position the hub at a predetermined position; and attaching a fixing member having a female thread to the male thread of the tubular potion to fix the recording medium.

According to the present invention, the fixing member which is screwed into male thread provided on the outer peripheral surface of the tubular portion of the hub. In this way, it is possible to provide a method for producing a disc driving apparatus which is miniaturized and have a reduced thickness while a strain or deflection of the recording medium generated due to the uneven pressure applied when the recording medium is fixed to the hub being eliminated and deformation of the hub due to deterioration of the relative strengths of the parts being suppressed.

According to the present invention, by shrinkage-fitting the fixing member to the tubular portion of the hub, or screwing the fixing member to the male thread provided on the outer peripheral surface of the tubular portion of the hub, no uneven pressure is applied to a recording medium and the thickness of the tubular portion in the radial direction can be minimized. In this way, the recording medium can have a smaller diameter with the same recording capacity, or can have a larger recording capacity with the same diameter. By providing the fixing member on the outer peripheral surface of the tubular portion of the hub, the thickness in the width direction can be smaller compared to that of the conventional disc driving apparatus. By providing the opening in the base, the recording medium can be fixed to the hub even after the recording medium is fixed. In this way, the strain or deflection of the recording medium which may be generated due to an uneven pressure applied when the recording medium is fixed to the hub is eliminated, and deformation of the hub due to deterioration of the relative strengths of the parts is reduced. As a result, it becomes possible to provide a spindle motor having the reduced size and thickness, a disc driving apparatus having the same, and a production method thereof.

### BRIEF DESCRIPTION OF THE DRAWINGS

FIG. 1 is a cross-sectional view showing a right half of a disc driving apparatus of Embodiment 1.

FIG. 2 is a cross-sectional view showing a right half of a disc driving apparatus of Embodiment 2.

FIG. 3 is a cross-sectional view showing a right half of a disc driving apparatus of Embodiment 3.

FIG. 4 is a diagram for illustrating a conventional assembling method for spindle motors.

FIG. 5 is a diagram for illustrating an assembling method for spindle motors according to the embodiments of the present invention.

FIG. 6 is a plan view showing a structure of a base.

FIG. 7 is a cross-sectional view showing a right half of a conventional disc driving apparatus.

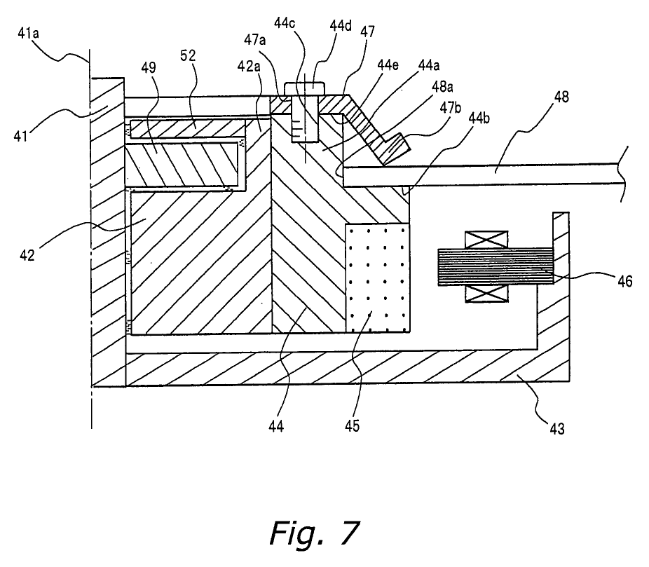

FIG. 8 is a plan view of a top end portion of a hub in the conventional disc driving apparatus.

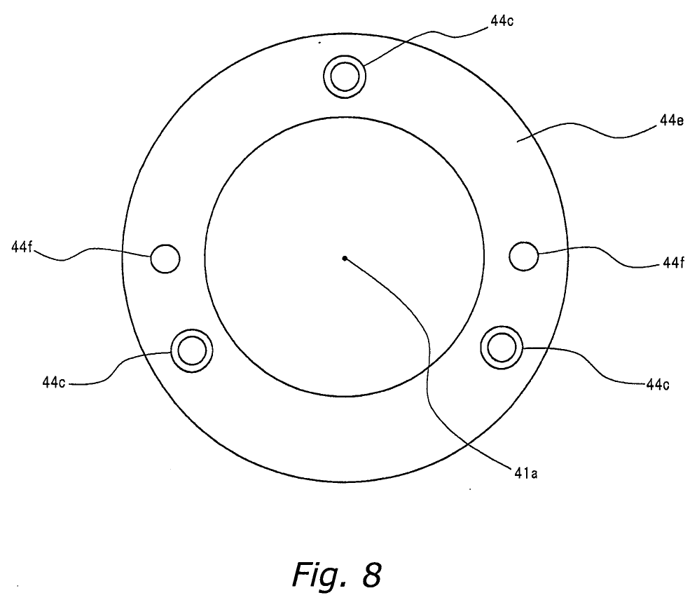

### DESCRIPTION OF THE PREFERRED EMBODIMENTS

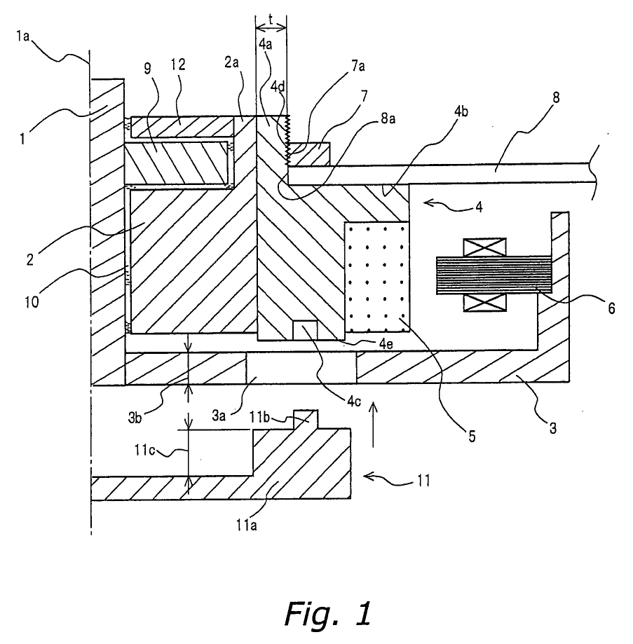

Hereinafter, preferred embodiments of the present invention will be described with reference to FIGS. 1 through 3.

(Embodiment 1)

The spindle motor of Embodiment 1 of the present invention will be described with reference to FIG. 1. FIG. 1 is a cross-sectional view showing a right half of a disc driving apparatus having a spindle motor of Embodiment 1. Since the other half on the left-hand side with respect to a central axis (axis 1a) has the same structure as the right half, it is not shown in the figure.

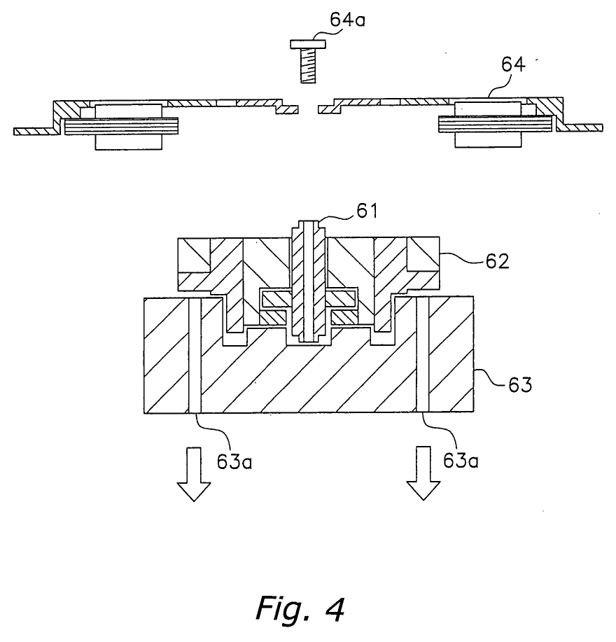

As shown in FIG. 1, a lower end portion of a shaft 1 is fixed to a base 3. The shaft 1 may be fixed to the base 3 by press fit, adhesion, welding or their combination as shown in FIG. 1. Alternately, as shown in FIG. 4, the shaft 1 may be fixed to the base 3 by a screw. To an outer peripheral surface of the shaft 1, a thrust flange 9 having a disc shape is fixed, or the thrust flange 9 is integrally formed with the shaft 1. A bearing has, for example, the following structure. A sleeve 2 has a cylindrical portion 2a. To an inner peripheral surface of the cylindrical portion 2a, a thrust plate 12 having a ring shape is press-fitted or adhered. The thrust flange 9 is positioned in a space defined by the sleeve 2, the cylindrical portion 2a, and the thrust plate 12. The sleeve 2 and the thrust plate 12 are rotatably supported by the shaft 1. On one of a lower surface of the thrust plate 12 and an upper surface of the thrust flange 9, one of a lower surface of the thrust flange 9 and an upper surface of the sleeve 2, and one of the outer peripheral surface of the shaft 1 and an inner peripheral surface of the sleeve 2, a dynamic pressure generating groove (not shown) having a herringbone shape or the like which is well-known in the art is respectively provided. In gaps 10 between the shaft 1 and the thrust plate 12, the thrust flange 9 and the thrust plate 12, the thrust flange 9 and the cylindrical portion 2a, the thrust flange 9 and the sleeve 2, and the shaft 1 and the sleeve 2, oil for lubrication is filled to form a hydrodynamic bearing. A length of the gap 10 in a radial direction is, for example, about 1 to 5 μm, and a length of the gap 10 in a thrust direction is, for example, about 20 to 60 μm. Thus, oil is held by a surface tension and prevented from running off.

To an outer peripheral surface of the sleeve 2, a hub 4 for holding a rotor magnet 5 is attached. A motor stator 6 is attached to the base 3 so as to oppose the rotor magnet 5. The hub 4 includes a tubular portion 4a which is to be inserted into a central hole 8a of a disc 8. The tubular portion 4a is coaxial with the sleeve 2. On an outer peripheral surface of the tubular portion 4a, a male thread 4d is formed. The hub 4 also includes a first receiving surface 4b which is connected to the tubular portion 4a and holds the disc 8 perpendicularly to the axis 1a. The hub 4 further includes a second receiving surface 4e including positioning holes 4c provided on a surface which opposes the first receiving surface 4b in an axial direction. The second receiving surface 4e protrudes downward below the level of the sleeve 2 and the rotor magnet 5.

The damper 7 is a fixing member which has a ring shape. On an inner peripheral surface of the damper 7, a female thread 7a is formed. The damper 7 is screwed into the male thread 4d provided on the outer peripheral surface of the tubular portion 4a, and fixes the disc 8 in cooperation with the first receiving surface 4b. Three positioning holes 4c are provided on the second receiving surface 4e with central angles of 120° with respect to the axis la. In the base 3, openings 3a are provided at the positions opposing the positioning holes 4c. The openings 3a are larger than the positioning holes 4c in diameters. Three openings 3a are provided with central angles of 120° with respect to the axis 1a.

A production process for a disc driving apparatus having the spindle motor of Embodiment 1 will be described. A positioning jig 11 used for assembling the disc driving apparatus is a member which has a ring shape and convex portions 11a at the positions corresponding to the three positioning holes 4c and openings 3a. In a top portion of each of the convex portion 11a, a protruding portion 11b to be inserted to the positioning holes 4c is provided. A width 11c of the convex portion 11a in the axial direction is larger than thickness 3b of the base 3.

First, the tubular portion 4a of the hub 4 is inserted into the central hole 8a of the disc 8, and the disc 8 is placed on the first receiving surface 4b. The protrusions 11b of the positioning jig 11 are inserted to the positioning holes 4c through the openings 3a of the base 3 so as to prevent the hub 4 from rotating. In such a state, the damper 7 is screwed into the male thread 4d of the tubular portion 4a. The disc 8 is interposed and fixed between the first receiving surface 4b and the lower surface of the damper 7. The openings 3a are sealed with a seal or the like for preventing dust and the like from entering into the disc driving apparatus therethrough.

As described above, in the disc driving apparatus having the spindle motor of Embodiment 1, the damper 7 having the female thread 7a is screwed into the male thread 4d provided on the outer peripheral surface of the tubular portion 4a of the hub 4. Thus, the entire circumference of the damper 7 presses near the central hole 8a of the disc 8. Since uniform pressure is applied near the central hole 8a of the disc 8, no strain or deflection is generated. The tubular portion 4a for fixing the disc 8 includes the male thread 4d formed in a direction parallel to the axis la. The damper 7 is screwed into the male thread 4d. Thickness t of the tubular portion 4a may be any value as long as it gives a sufficient strength for the male thread 4d to hold the damper 7. Unnecessarily large thickness t is not required. In Embodiment 1, the positioning holes 4c are formed on the second receiving surface 4e. Thus, the thickness t of the tubular portion 4a can be minimized. Further, since the damper 7 is provided on the outer peripheral surface of the tubular portion 4a of the hub 4, the width in the axial direction can be made smaller compared to that in the conventional disc driving apparatus.

Since the downward pressure applied when the damper 7 is screwed into the male thread 4d is supported by inserting the protrusions 11b of the positioning jig 11 into the positioning holes 4c, no uneven pressure is applied to the parts of the spindle motor such as the hub 4. In this way, deformation of the parts due to the deteriorated strengths can be reduced even when the spindle motor is miniaturized and has a reduced thickness. Further, even after the base 3 is attached, the protrusions 11a of the positioning jig 11 can be inserted through the openings 3a to fix the disc 8 to the hub 4 with the hub 4 being prevented from rotating.

In this way, it becomes possible to realize the spindle motor which is miniaturized and have a reduced thickness while deformation of the hub due to deterioration of the relative strengths of the parts being suppressed, the disc driving apparatus having the same and the production method thereof.

In Embodiment 1, the shaft 1 may be fixed to the base 3 by press fit, adhesion, welding or their combination. Similar effects can be achieved if the shaft 1 is fixed to the base 3 by a screw.

In addition, similar effects can be achieved if the bearing does not have the structure shown in the figure.

In Embodiment 1, the openings 3a, the positioning holes 4c and the protrusions 11a of the positioning jig 11 are respectively provided at three positions with the central angles of 120° with respect to the axis 1. However, similar effects can be achieved if there are two or more openings 3a, the positioning holes 4c and the protrusions 11a are provided.

In Embodiment 1, the second receiving surface 4e is protruded downward below the sleeve 2 and the rotor magnet 5. However, when the positioning holes 4c are provided and the thickness in the radial direction of the protrusion 11a is made smaller compared to that in the radial direction of the second receiving surface 4e, it is not necessarily protruded.

In Embodiment 1, an elastic member such as rubber member may be inserted between the damper 7 and the disc 8 as necessary. Such an elastic member will be described below in more detail.

(Embodiment 2)

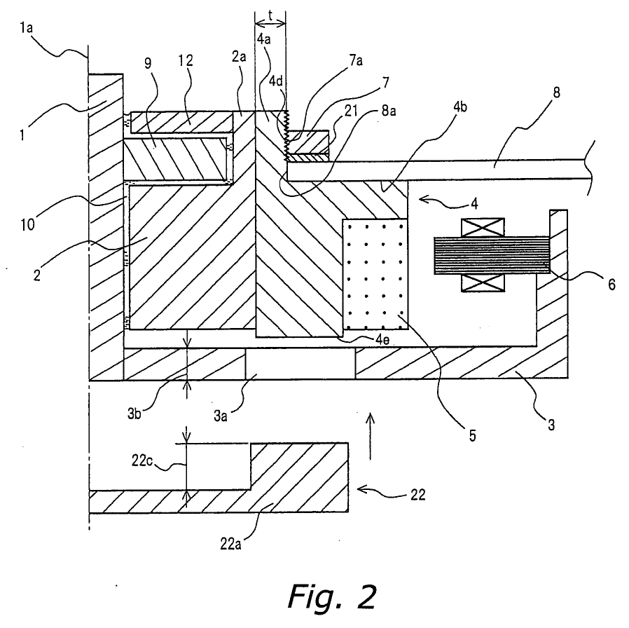

With reference to FIG. 2, a spindle motor of Embodiment 2 will be described. FIG. 2 is a cross-sectional view showing a right half of a disc driving apparatus having a spindle motor of Embodiment 2. Since the other half on the left-hand side with respect to a central axis (axis 1a) has the same structure as the right half, it is not shown in the figure.

As shown in FIG. 2, Embodiment 2 is different from Embodiment 1 on the points that the positioning holes 4c in Embodiment 1 as shown in FIG. 1 are not provided, a spring member 21 is provided between the lower surface of the damper 7 and the upper surface of the disc 8, and a receiving jig 22 is included instead of the positioning jig 11. Since the rest of the structure is same as that in Embodiment 1, the description which will overlap is omitted.

The spring member 21 is an elastic member having a ring shape which is formed of a rubber material or the like. It absorbs changes in the pressure to the disc 8 due to a temperature change and the like and it also protects the surface of the disc 8 from the damper 7. The receiving jig 22 has three protrusions 22a at positions corresponding to the openings 3a. A substance having a large frictional force is attached to or used for surface-treatment of an upper surface of each of the protrusions 22a. The width 22c of each of the protrusions 22a in the axial direction is larger than the thickness 3b of the base 3.

The production process of the disc driving apparatus including the spindle motor of Embodiment 2 will be described. The tubular portion 4a of the hub 4 is inserted into the central hole 8a of the disc 8, and the disc 8 is placed on the first receiving surface 4b. The spring member 21 is fitted to the tubular portion 4a of the hub 4, and is placed on the upper surface of the disc 8. The protrusions 22a of the receiving jig 22 are inserted to the openings 3a of the base 3 from the lower side toward the upper side as shown in FIG. 2 to bring the upper surface of the protrusions 22a into contact with the second receiving surface 4e. With the frictional force between the upper surface of the protrusions 22a and the second receiving surface 4e in contact with each other, the damper 7 having the female thread 7a is screwed into the male thread 4d of the tubular portion 4a while the hub 4 being prevented from rotating. The disc 8 is interposed and fixed between the first receiving surface 4b and the lower surface of the damper 7 via the spring member 21. The openings 3a are sealed with a seal or the like for preventing dust and the like from entering into the disc driving apparatus therethrough.

As described above, in the disc driving apparatus having the spindle motor of Embodiment 2, the damper 7 having the female thread 7a is screwed into the male thread 4d provided on the outer peripheral surface of the tubular portion 4a of the hub 4. Thus, the entire circumference of the damper 7 presses near the central hole 8a of the disc 8. Since uniform pressure is applied near the central hole 8a of the disc 8, no strain or deflection is generated. The tubular portion 4a for fixing the disc 8 includes the male thread 4d formed in a direction parallel to the axis la. The damper 7 is screwed into the male thread 4d. Thickness t of the tubular portion 4a may be any value as long as it gives a sufficient strength for the male thread 4d to hold the damper 7. Unnecessarily large thickness t is not required. When the hub 4 can be prevented from rotating by a frictional force between the second receiving surface 4e and the upper surfaces of the protrusions 22a of the receiving jig 22 in contact with each other, there is no need to provide a positioning hole in the tubular portion 4a. Thus, the thickness t of the tubular portion 4a in the radial direction can be minimized. Further, since the damper 7 is provided on the outer peripheral surface of the tubular portion 4a of the hub 4, the width in the axial direction can be made smaller compared to that in the conventional disc driving apparatus.

Since the downward pressure applied when the damper 7 is screwed into the male thread 4d is supported by bringing the protrusions 22a of the receiving jig 22 into contact with the second receiving surface 4e, no uneven pressure is applied to the parts of the spindle motor such as the hub 4. In this way, deformation of the parts due to deteriorated strengths can be reduced even when the spindle motor is miniaturized and have a reduced thickness. Further, even after the base 3 is attached, the protrusions 22a of the receiving jig 22 can be inserted through the openings 3a to fix the disc 8 to the hub 4 with the hub 4 being prevented from rotating. In this way, it becomes possible to realize the spindle motor which is miniaturized and have a reduced thickness while deformation of the hub due to deterioration of the relative strengths of the parts being suppressed, the disc driving apparatus having the same and the production method thereof In Embodiment 2, the openings 3a, and the protrusions 22a of the positioning jigs 22 are respectively provided at three positions with the central angles of 120° with respect to the axis 1. However, similar effects can be achieved if two or more openings 3a and the protrusions 22a of the positioning jigs 22 are provided.

In Embodiment 2, the spring member 21 is provided for absorbing changes in the pressure to the disc 8. However, if it is not necessary depending on the situation, it may not be provided.

(Embodiment 3)

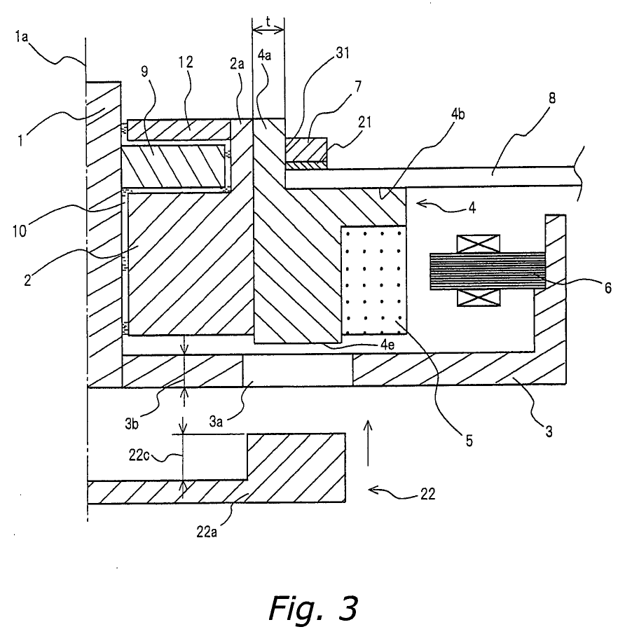

With reference to FIG. 3, a spindle motor of Embodiment 3 will be described. FIG. 3 is a cross-sectional view showing a right half of a disc driving apparatus having a spindle motor of Embodiment 3. Since the other half on the left-hand side with respect to a central axis (axis 1a) has the same structure as the right half, it is not shown in the figure.

As shown in FIG. 3, Embodiment 3 includes a shrinkage fit portion 31 instead of the male thread 4d of the hub 4 and the female thread 7a of the damper 7 in Embodiment 2 as shown in FIG. 2. Since the rest of the structure is same as that in Embodiment 1, the description which will overlap is omitted.

The shrinkage fit portion 31 is formed by first heating the damper 7 such that it expands and has an extended diameter. Then, in such a state, the damper 7 is fitted to the outer peripheral surface of the tubular portion 4a, and is cooled until it is fixed to the tubular portion 4a.

A production process of the disc driving apparatus including the spindle motor of Embodiment 3 will be described. The tubular portion 4a of the hub 4 is inserted into the central hole 8a of the disc 8, and the disc 8 is placed on the first receiving surface 4b. The spring member 21 is fitted to the tubular portion 4a of the hub 4, and is placed on the upper surface of the disc 8. The protrusion 22a of the receiving jig 22 is inserted into the openings 3a of the base 3 from the lower side toward the upper side as shown in FIG. 3 to bring the upper surfaces of the protrusions 22a of the receiving jig 22 into contact with the second receiving surface 4e. As described above, with the frictional force between the upper surfaces of the protrusions 22a of the receiving jig 22 which have a substance having a large frictional force attached thereto or which are surface-treated with such a substance, and the second receiving surface 4e in contact with each other, the hub 4 is prevented from rotating. In such a state, the damper 7 is shrinkage-fitted to the tubular portion 4a at the shrinkage fit portion 31. The disc 8 is interposed and fixed between the first receiving surface 4b and the lower surface of the damper 7 via the spring member 21. The openings 3a are sealed with a seal or the like for preventing dust and the like from entering into the disc driving apparatus therethrough.

As described above, in the disc driving apparatus having the spindle motor of Embodiment 3, the inner peripheral surface of the damper 7 is shrinkage-fitted to the outer peripheral surface of the tubular portion 4a of the hub 4 at the shrinkage fit portion 31. Thus, the entire circumference of the damper 7 presses near the central hole 8a of the disc 8. Since uniform pressure is applied near the central hole 8a of the disc 8, no strain or deflection is generated. In the shrinkage-fitting step, no pressure is applied to the parts. Thus, deformation of the hub 4 is not generated. In this way, there is no need for providing a positioning hole in the tubular portion 4a. Thus, the thickness t in radial direction of the tubular portion 4a can be minimized. Further, since the damper 7 is provided on the outer peripheral surface of the tubular portion 4a of the hub 4, the width in the axial direction can be made smaller compared to that in the conventional disc driving apparatus. Further, even after the base 3 is attached, the protrusions 22a of the receiving jig 22 can be inserted through the openings 3a to fix the disc 8 to the hub 4 with the hub 4 being prevented from rotating.

In this way, it becomes possible to realize the spindle motor which is miniaturized and have a reduced thickness while deformation of the hub due to deterioration of the relative strengths of the parts being suppressed, the disc driving apparatus having the same and the production method thereof.

In Embodiment 3, the inner peripheral surface of the damper 7 is shrinkage-fitted to the outer peripheral surface of the tubular portion 4a. Thus, a pressure which may cause deformation of the hub 4 is not generated basically. Therefore, it is not necessary to use the receiving jig 22 to prevent the hub 4 from rotating. However, depending on a method of operation, a force may be applied in a rotation direction. Thus, in view of improving the stability of operations when the disc 8 is fixed, the openings 3a, and the second receiving surface 4e are provided to allow the receiving jig 22 to be inserted. For preventing the hub 4 from rotating in order to improve the stability of the operations, similarly to Embodiment 1 as shown in FIG. 1, the positioning jig 11 may be provided instead of the receiving jig 22, the positioning holes 4c may be provided on the second receiving surface 4e, and the protrusions 11b of the positioning jig 11 may be inserted into the positioning holes 4c.

In Embodiment 3, the spring member 21 is provided for protecting the surface of the disc 8. However, if it is not necessary depending on the situation, it may not be provided.

(Others)

(1) In each of the embodiments of the present invention, a flat surface perpendicular to the axis 1a may be provided under the damper 7, and thus, a uniform pressure can be applied to the entire circumference of the central hole 8a of the disc 8 more securely and the strain and deflection can be prevented from being generated.

(2) In each of the embodiments of the present invention, the bearing structure is the one having one end of the axis being fixed. However, the bearing structure used in the present invention is not limited to this type.

(3) In each of the embodiments of the present invention, a hydrodynamic bearing is formed between the shaft 1 and the sleeve 2. However, of course, similar effects can be achieved by a bearing having a different structure.

(4) Hereinafter, a method for assembling each of the spindle motors described in the embodiments will be described. Here, the spindle motor having a structure in which the shaft 1 is fixed to the base 3 by a screw will be described. The effects of the second receiving surface 4e provided on the hub 4 and the openings 3a provided in the base 3 will also be described.

First, with reference to FIG. 4, a conventional method for assembling a spindle motor will be described.

The conventional assembling method includes: (1) a first step for placing a hub unit 62 including a bearing unit 61 on a receiving jig 63; (2) a second step for absorbing air from a suction hole 63a provided on the receiving jig 63 and fixing the hub unit 62 to the receiving jig 63; (3) a third step for positioning and fixing the base unit 64 to the hub unit 62 placed on the receiving jig 63; and (4) a fourth step for fixing the base unit 64 and the hub unit 62 positioned and fixed in the third step.

Herein, the bearing unit 61 is formed of members forming a hydrodynamic bearing, and is formed of the shaft 1, the thrust flange 9, the sleeve 2, and the thrust plate 12 (see FIGS. 1 through 3). The hub unit 62 includes a bearing unit 61 and further includes the hub 4 and the rotor magnet 5 (see FIGS. 1 through 3). The base unit 64 is formed of the base 3 and the motor stator 6 (see FIGS. 1 through 3).

In the first step, the hub unit 62 is placed on the receiving jig 63. The receiving jig 63 has a shape which can accommodate a side of the hub unit 62 on which the disc is placed (a side opposite to the side where the base unit 64 is attached). The receiving jig 63 supports the shaft 1, the thrust plate 12, the hub 4 and the like in the hub unit 62 in the axial direction when the hub unit 62 is placed on the receiving jig 63. Further, the receiving jig 63 includes suction holes 63a at a plurality of positions (for example, at positions) in a circumferential direction at radial positions corresponding to the first receiving surface 4b of the hub 4. The suction holes 63a are connected to a suction pump which is not shown.

In the second step, the suction pump is operated to suck air from the suction holes 63a. The first receiving surface 4b of the hub 4 which is placed so as to cover the suction holes 63a is sucked, and the hub unit 62 is sucked and fixed to the receiving jig 63.

In the third step, the base unit 64 is positioned and fixed to the hub unit 62 fixed to the receiving jig 63. At this time, the base unit 64 is positioned and attached so as to fit the outer peripheral portion of the shaft 1 to a shaft insertion hole provided in the base unit 64.

In the fourth step, a screw 64a is screwed into a screw hole provided in the center of the shaft 1 to fix the base unit 64 and the hub unit 62. With respect to the spindle motors shown in FIGS. 1 through 3, the structure which does not include a screw hole in the shaft 1 has been shown. However, in such a structure, the base unit 64 and the hub unit 62 are fixed by press-fitting and adhering the outer peripheral portion of the shaft 1 to the shaft insertion hole of the base unit 64.

The conventional assembling method as described above has the following problems. The base 3 and the motor stator 6 which form the base unit 64 are magnetic bodies. Thus, when the base unit 64 is positioned and fixed to hub unit 62 in the third step, the base unit 64 and the rotor magnet 5 of the hub unit 62 adsorb each other. Accordingly, if the adsorption force between the base unit 64 and the rotor magnet 5 of the hub unit 62 is larger than the suction force for the receiving jig 63 to suck the hub unit 62, when the base unit 64 is brought near the hub unit 62 in the third step, the hub unit 62 is lifted from the receiving jig 63 and is adsorbed to the base unit 64 with a shock. Such an adsorption with a shock may cause bubbles to be generated in the oil in the bearing unit 61, which may result in deterioration of the bearing performance.

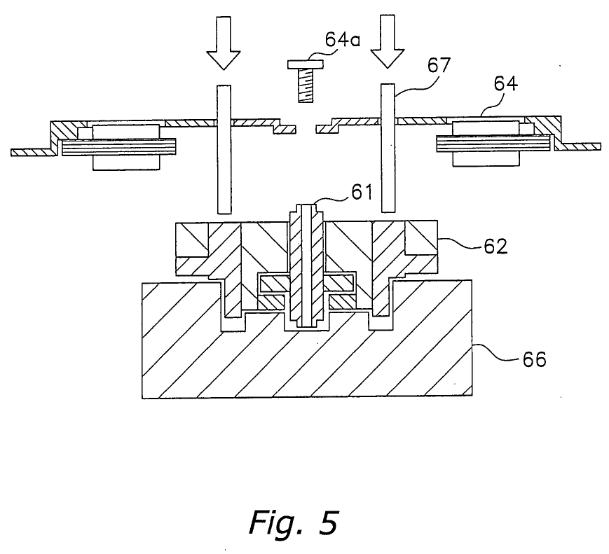

Next, with reference to FIG. 5, an assembling method according to the present embodiment will be described.

The assembling method of the present embodiment includes: (1) a first step for placing a hub unit 62 including a bearing unit 61 on a receiving jig 66; (2) a second step for inserting a hub unit holding shafts 67 into the openings 3a provided in the base 3 of the base unit 64; (3) a third step for descending the hub unit holding shaft 67 to press the hub 4 of the hub unit 62 placed on the receiving jig 66 to the receiving jig 66; (4) a fourth step for positioning and fixing the base unit 64 to the hub unit 62 along the hub unit holding shafts 67; and (5) a fifth step for fixing the base unit 64 and the hub unit 62 positioned and fixed in the fourth step.

In the first step, the hub unit 62 is placed on the receiving jig 66. The receiving jig 66 has a shape which can accommodate a side of the hub unit 62 on which the disc is placed (a side opposite to the side where the base unit 64 is attached). The receiving jig 66 supports the shaft 1, the thrust plate 12, the hub 4 and the like in the hub unit 62 in the axial direction when the hub unit 62 is placed on the receiving jig 66.

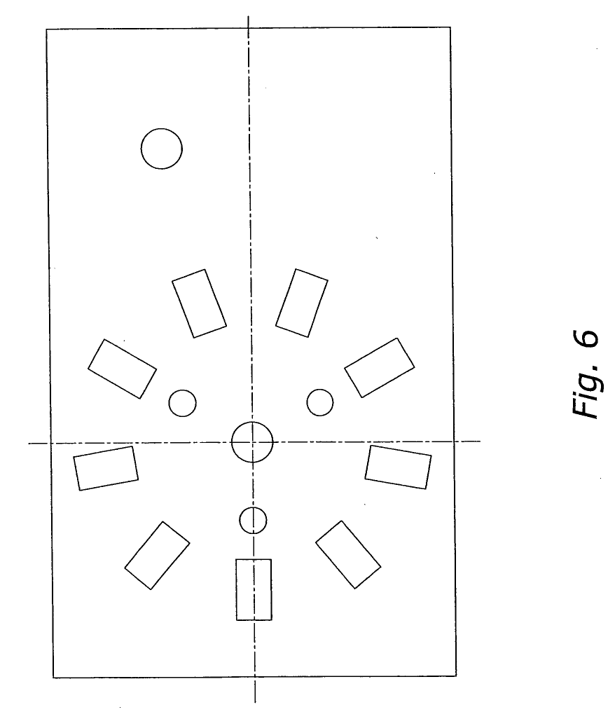

In the second step, the hub unit holding shafts 67 provided at positions corresponding to the openings 3a of the base unit 64 placed on the receiving jig 66 is inserted into the openings 3a. The openings 3a are provided at three positions in a circumferential direction in a midway between the shaft insertion holes of the base unit 64 and the motor stator 6 in the radial direction as shown in FIG. 6. The hub unit holding shafts 67 include three shafts provided at positions corresponding to the openings 3a of the base unit 64 placed on the receiving jig 66. Further, the hub unit holding shafts 67 may be provided in, for example, a spindle motor assembling apparatus including the receiving jig 66, and the relative position with respect to the receiving jig 66 may be changed. The hub unit holding shafts 67 are inserted into the openings 3a of the base unit 64 from the sides of the hub unit holding shafts 67 facing the receiving jig 66 which are spaced apart from the receiving jig 66 by a predetermined gap.

In the third step, with the hub unit holding shafts 67 being inserted into the openings 3a, the hub unit holding shafts 67 are brought closer to the receiving jig 66 such that the hub unit holding shafts 67 press the second receiving surface 4e of the hub unit 62.

In the fourth step, the base unit 64 is brought closer to the hub unit 62 along the hub unit holding shafts 67. The base unit 64 is positioned and attached such that the outer peripheral portion of the shaft 1 is fitted to the shaft insertion hole provided in the base unit 64. At this time, the hub unit 62 and the receiving jig 66 may be move toward the base unit 64.

In the fifth step, a screw 64a is screwed into a screw hole provided in the center of the shaft 1 to fix the base unit 64 and the hub unit 62. When they are fixed, the hub unit 62 is pressed by the hub unit holding shafts 67. With respect to the spindle motors shown in FIGS. 1 through 3, the structure which does not include a screw hole in the shaft 1 has been shown. However, in such a structure, the base unit 64 and the hub unit 62 are fixed by press-fitting and adhering the outer peripheral portion of the shaft 1 to the shaft insertion hole of the base unit 64.

The assembling method according to the present embodiment as described above have the following effects. The base unit 64 and the hub unit 62 is positioned and fixed to the hub nit 62 while the hub unit 62 being pressed by the hub unit holding shafts 67. Thus, it becomes possible to prevent the hub unit 62 from being lifted, which may occur in the conventional assembling method. In this way, adsorption with a shock between the base unit 64 and the hub unit 62 can be prevented. Accordingly, bubbles which may be generated in the oil in the bearing unit 61 can be prevented and it becomes possible to improve the bearing performance. Further, since there is no need to use a jig having a sucking mechanism as a conventional receiving jig 63, the structure of the spindle motor assembling apparatus can be simplified. Consequently, the cost of equipment can be reduced.

The assembling method according to the present embodiment as described above is not limited to assembling the spindle motors shown in FIGS. 1 through 3. It can be widely applied to spindle motors having the openings in their bases.

The present invention is useful in spindle motors, disc driving apparatuses having the same, and production methods thereof.

1. A spindle motor comprising:
a sleeve which is supported by a fixed shaft and rotates around a predetermined axis; and
a hub provided on an outer peripheral portion of the sleeve, which includes:
a tubular portion to be inserted into a central hole of a recording medium having a disc shape, which is coaxial with the sleeve and has a male thread formed on an outer peripheral surface; and
a first receiving surface which is connected to the tubular portion and which holds the recording medium to the axis.

2. A spindle motor according to claim 1, wherein the hub includes at least two positioning holes formed on a surface opposing the first receiving surface in an axial direction.

3. A spindle motor according to claim 1, comprising a base which is fixed to the shaft and includes at least two openings which oppose the positioning holes and are larger than the positioning holes.

4. A spindle motor according to claim 1, comprising a hydrodynamic bearing having a lubricant formed between the shaft and the sleeve.

5. A disc driving apparatus, comprising:
a sleeve which is supported by a fixed shaft and rotates around a predetermined axis;
a hub which is provided on an outer peripheral portion of the sleeve, including a tubular portion to be inserted into a central hole of a recording medium having a disc shape, which is coaxial with the sleeve, and a first receiving surface which is connected to the tubular portion and holds the recording medium to the axis; and
a fixing member which is attached to an outer peripheral surface of the tubular portion of the hub and fixes a recording medium placed on the first receiving surface,
wherein the fixing member is a member having a ring shape fixed to the tubular portion by a shrinkage fit.

6. A disc driving apparatus, comprising:
a sleeve which is supported by a fixed shaft and rotates around a predetermined axis;
a hub which is provided on an outer peripheral portion of the sleeve, including a tubular portion to be inserted into a central hole of a recording medium having a disc shape, which is coaxial with the sleeve and has a male thread formed on an outer peripheral surface, and a first receiving surface which is connected to the tubular portion and holds the recording medium to the axis; and
a fixing member which is attached to an outer peripheral surface of the tubular portion of the hub and fixes a recording medium placed on the first receiving surface,
wherein the fixing member has a female thread to be attached to the male thread on an inner peripheral surface thereof.

7. A disc driving apparatus according to claim 5, wherein the hub further includes at least two positioning holes formed on a surface opposing the first receiving surface in an axial direction.

8. A disc driving apparatus according to claim 5, further comprising a base which is fixed to the shaft and includes at least two openings which oppose the positioning holes and are larger than the positioning holes.

9. A disc driving apparatus according to claim 5, comprising a hydrodynamic bearing having a lubricant which is formed between the shaft and the sleeve.

10. A method for producing a spindle motor including:
a hub unit including a bearing unit which includes a shaft and a sleeve relatively rotatable with respect to the shaft, a hub which is fixed to one of the shaft and the sleeve and on which a recording medium can be placed, and a rotor magnet to be fixed to the hub, and
a base unit including a base fixed to the other of the shaft and the sleeve and a stator fixed in the base opposing the rotor magnet in a radial direction, the method comprising:
inserting a positioning restriction section for restricting an axial direction position of the hub unit relatively into an opening provided in the base from the side of base unit with the hub unit and the base unit being spaced apart from each other in an axial direction to abut the hub unit against the hub; and
moving the base unit and the hub unit relatively along the positioning restriction section to positioning and fix the base unit to the hub unit.

11. A method for producing a disc driving apparatus comprising a spindle motor which includes:
a sleeve which is supported by a fixed shaft and rotates around a predetermined axis; and
a hub which is provided on an outer peripheral portion of the sleeve, including a tubular portion to be inserted into a central hole of a recording medium having a disc shape, which is coaxial with the sleeve, and a first receiving surface which is connected to the tubular portion and holds the recording medium to the axis, the method comprising:
inserting the tubular portion of the hub into a central hole of the recording medium to attach the recording medium to the first receiving surface; and
inserting the fixing member with a shrinkage fit to an outer peripheral surface of the tubular potion of the hub to fix the recording medium.

12. A method for producing a disc driving apparatus comprising a spindle motor which includes:
a sleeve which is supported by a fixed shaft and rotates around a predetermined axis; and
a hub which is provided on an outer peripheral portion of the sleeve, including a tubular portion to be inserted into a central hole of a recording medium having a disc shape, which is coaxial with the sleeve and has a male thread formed on an outer peripheral surface, a first receiving surface which is connected to the tubular portion and holds the recording medium to the axis, and at least two positioning holes formed on a surface opposing the first receiving surface in an axial direction, the method comprising:
inserting the tubular portion of the hub into a central hole of the recording medium to attach the recording medium to the first receiving surface;
inserting a positioning jig into the positioning holes to position the hub at a predetermined position; and
attaching a fixing member having a female thread to the male thread of the tubular potion to fix the recording medium.

13. A disc driving apparatus according to claim 6, wherein the hub further includes at least two positioning holes formed on a surface opposing the first receiving surface in an axial direction.

14. A disc driving apparatus according to claim 6, further comprising a base which is fixed to the shaft and includes at least two openings which oppose the positioning holes and are larger than the positioning holes.

15. A disc driving apparatus according to claim 6, comprising a hydrodynamic bearing having a lubricant which is formed between the shaft and the sleeve.
